(19) United States
(12) Patent Application Publication
(10) Pub. No.: US 2003/0210861 A1
(43) Pub. Date: Nov. 13, 2003

(54) Individually addressable laser diode arrays based imaging systems with increased redundancy

(75) Inventors: Alex Weiss, Kadima (IL); Nissim Pilossof, Rehovot (IL); Daniel Gelbart, Vancouver (CA)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Creo IL. Ltd.

(21) Appl. No.: 10/142,827

(22) Filed: May 13, 2002

(51) Int. Cl. G02B 6/32; G02B 6/38

(52) U.S. Cl. 385/33; 385/59

(57) ABSTRACT

A method and apparatus for increasing the redundancy of IALDA-based imaging devices and for increasing their serviceability. The functioning emitters are coupled to an array of optical fibers, leaving some of the functioning emitters as spare. The second ends of the optical fibers are arranged in an equidistance array, optionally passing through multi-fiber connectors or through an optical switchboard.

### FIELD OF THE INVENTION

The present invention is related to electronic imaging systems and particularly to imaging systems utilizing Individually Addressable Laser Diode Arrays (IALDA).

### BACKGROUND OF THE INVENTION

Electronic imaging systems, particularly those used in graphic arts applications, often use multiple laser sources working in parallel in order to increase the imaging speed. Such systems are described, for example, in U.S. Pat. Nos. 5,812,179 (Pensavecchia, et al.) and 5,168,288 (Baek, et al.). They use individual laser diode devices, which cannot be packed close together because of the size of their package. Therefore, the individual light sources are coupled to optical fibers, which are closely packed together by arranging the fibers' ends in an array, using V-groove or similar assembly means. This array is then imaged on a medium.

An alternative approach to densely packed laser sources is a monolithic emitting device, comprising a plurality of individually addressable laser emitters formed on a single semiconductor wafer A number of documents, such as U.S. Pat. Nos. 4,531,217 (Kitamura), 4,520,471 (Carlin) and 5,986,819 (Steinblatt) describe the use of such Individually Addressable Laser Diode Arrays (IALDA) for imaging applications. An additional advantage of the IALDA solution over the array of individual pigtailed lasers, besides the densely packed laser sources, is its low relative cost per emitter since all emitters are in a single package. Therefore, there is a strong economical justification for using IALDA for imaging applications.

There are, however, also some drawbacks. For better understanding of these drawbacks a typical IALDA-based imaging system, disclosed in U.S. Pat. No. 5,986,819 (Steinblatt), is illustrated in FIG. 1. In this example, the medium 12 is wrapped around a rotating drum 14, thus presenting a typical external-drum imagesetter, but other configuration such as flatbed imagesetter are also possible. The IALDA device 10 consists of lasing sections (emitters) 11, spaced by non lasing section and is positioned with its emitting surface 13 essentially parallel to the medium section being scanned (or written on). The light emitted from each IALDA emitter 11 is projected on the medium 12 with the help of the optical system 16, 18. In other words, each spot 15 on the medium 12 is an image of a corresponding emitter 11. Therefore, all emitters 11 should he arranged in sequence and should be equidistant.

The above requirement creates the first drawback of the classical IALDA-based imaging system: For the system to function, all IALDA emitters should function properly. As a result, as soon as one of its emitters fails, the IALDA should be replaced. This drawback is especially strong in graphic arts imaging applications, where the power required from each emitter is in the order of 0.5W and the life span of an emitter can be as low as several hundred hours.

Seconds the production yield of an IALDA with 100% finctioning emitters can be as low as 20%. This raises the cost of the device and cancels, to a great extent, the cost advantage of the single package. At the same time, the manufacturing yield of an IALDA with 90% functioning emitters can be as high as 97% of the total production volume.

Third, IALDA replacement is a costly operation, requiring sophisticated optical adjustments, making it virtually impossible in field conditions. The entire optical imaging device (optical head) must be shipped to a specialized laboratory, repaired, returned to the customer and mounted and adjusted on the machine by a qualified service engineer.

In an attempt to address the first drawback, a number of redundancy schemes were proposed. For example, in U.S. Pat. No. 5,594,752 (Endriz) multiple emitters contribute to the same light spot. When an emitter fails, the other emitters of the group contributing to the same spot will be operated at increased power, in order to compensate for the loss caused by the failed emitter.

Another approach is suggested in Patent application No. WO0203679 (Steinblatt), in which the IALDA device is backed-up by a second identical one. When an emitter fails, the corresponding emitter in the backup IALDA undertakes its function.

Despite the fact that the above-cited documents deal with the problem of redundancy, they fail to address the production yield mid field serviceability issues, In addition, the solutions proposed are sophisticated and require precise and extensively optical adjustment operations.

### SUMMARY OF THE INVENTION

The present invention provides a method for increasing the redundancy of IALDA-based imaging devices. It also successfully solves the issues of using IALDAs with non-functioning emitters and provides for easily serviceable IALDA-based imaging systems.

The present invention describes a simple and easy way or coupling IALDA emitters to an array of optical fibers. The optical fibers art then arranged in an array, taking into account only the initially functioning (i.e as manufactured) IALDA emitters, thus utilizing almost the full volume of manufactured IALDA.

In one aspect of the present invention there is provided an optical imaging system comprising:

At least one Individually Addressable Laser Diode Array (IALDA) comprising a plurality of emitters and a plurality of optical fibers coupled in one end thereof with said emitters, wherein second ends of at least part of said optical fibers coupled with functioning emitters are arranged in a consecutive array of equidistant sources, and wherein one or more of said optical fibers coupled with functioning emitters are left as spare for increased redundancy.

The coupling of the emitters with the optical fibers may be made with a single anamorphic lens, common to all said emitters.

The consecutive array of equidistant sources comprises a V-groove assembly.

In another aspect of the present invention there is provided an optical imaging system comprising:

At least one Individually Addressable Laser Diode Array (IALDA) comprising a plurality of emitters and a plurality of optical fibers coupled in one end thereof with said emitters, wherein second ends of at least part of said optical fibers coupled with functioning emitters are arranged in a consecutive array of equidistant sources, and wherein one or more of said optical fibers coupled with functioning emitters are left as spare for increased redundancy, and at least one multi-fiber connector for each of said at least one IALDA, each of said at least one multi-fiber connectors comprising two detachable parts, wherein said optical fibers coupled to functioning emitters are routed through said two parts of said multi-fiber connectors.

The consecutive array of equidistant sources comprises a V-groove assembly.

In another aspect of the present invention there is provided an optical imaging system comprising:

At least one Individually Addressable Laser Diode Array (IALDA) comprising a plurality of emitters and a plurality of optical fibers coupled in one end thereof with said emitters, wherein second ends of at least part of said optical fibers coupled with functioning emitters are connected with an optical switchboard.

The optical fibers emerging from said optical switchboard are arranged in a consecutive array of equidistant sources which may be arranged in a V-groove assembly.

In another aspect of the present invention there is provided an optical imaging system comprising:

At least one Individually Addressable Laser Diode Array (IALDA) comprising a plurality of emitters, a plurality of optical fibers coupled in one end thereof with said emitters and a V-groove assembly for arranging second ends of at least part of said optical fibers connected to functioning emitters in a consecutive array of equidistant sources.

In another aspect of the present invention there is provided an optical imaging system comprising:

At least one Individually Addressable Laser Diode Array (IALDA) comprising a plurality of emitters, a plurality of optical fibers coupled in one end thereof with said emitters, one or more multi-fiber connectors, each of said multi-fiber connectors comprising two detachable parts, wherein at least part of said optical fibers coupled to functioning emitters are routed through said two parts of said multi-fiber connectors and a V-groove assembly for arranging second ends of said optical fibers emerging from said one or more multi-fiber connectors in a consecutive array of equidistant sources.

In another aspect of the present invention there is provided an optical imaging system comprising:

At least one Individually Addressable Laser Diode Array (IALDA) comprising a plurality of emitters a plurality of optical fibers coupled in one end thereof with said emitters, an optical switchboard for receiving a second end of at least part of said optical fibers coupled with functioning emitters and a V-groove assembly for arranging optical fibers emerging from said optical switchboard in a consecutive array of equidistant sources.

In another aspect of the present invention there is provided a method of increasing the redundancy of an IALDA-based imaging device, comprising the steps of:

Providing at least one Individually Addressable Laser Diode Array (IALDA) comprising a plurality of emitters and coupling a plurality of optical fibers in one end thereof with said emitters, wherein second ends of at least part of said optical fibers coupled with functioning emitters are arranged in an array, and wherein one or more of said optical fibers coupled with functioning emitters are left as spare for increased redundancy.

Optical fibers connected with failed emitters may be cut-off and connected with spare emitters.

In another aspect of the present invention there is provided a method of replacing an IALDA device having a plurality of emitters and optical fibers coupled in one end thereof with said emitters, wherein second ends of at least part of said optical fibers coupled with functioning emitters are arranged in an array, comprising the steps of:

cutting off said fibers at said second ends thereof;

replacing said IALDA device; and

optically connecting said replaced IALDA device by fusing the second ends of at least part of said optical fibers connected with functioning emitters.

In another aspect of the present invention there is provided a method of replacing an IALDA device having a plurality of emitters and optical fibers coupled in one end thereof with said emitters, wherein second ends of at least part of said optical fibers coupled with functioning emitters are connected to a multi-fiber connectors comprising the steps of:

disengaging said fibers at said second ends thereof by opening said connector;

replacing said IALDA device;

optically connecting said replaced IALDA device by engaging the second ends of at least part of said optical fibers connected with functioning emitters with said connector; and

closing said connector.

In another aspect of the present invention there is provided a method of replacing an IALDA device having a plurality of emitters and optical fibers coupled in one end thereof with said emitters, wherein second ends of at least part of said optical fibers coupled wit functioning emitters are connected to an optical switchboard, comprising the steps of.

disconnecting said fibers at second ends thereof from said switchboard;

replacing said IALDA device; and

optically connecting said replaced IALDA device by connecting the second ends of at least part of said optical fibers connected with functioning emitters with said optical switchboard.

### BRIEF DESCRIPTION OF THE DRAWINGS

FIG. 1 schematically illustrates a classic IALDA-based imaging system;

FIG. 2 schematically illustrates IALDA devices coupled to arranged optical-fiber bundles with spare emitters, according to a first embodiment of the present invention;

FIG. 3 schematically presents the embodiment of FIG. 2 with added multi-fiber optical connectors, according to a second embodiment of the present invention; and

FIG. 4 schematically presents the embodiment of FIG. 2 with added switchboard accommodating a plurality of individual optical connectors, according to a third embodiment of the present invention.

### DETAILED DESCRIPTION OF PREFEERED EMBODIMENTS

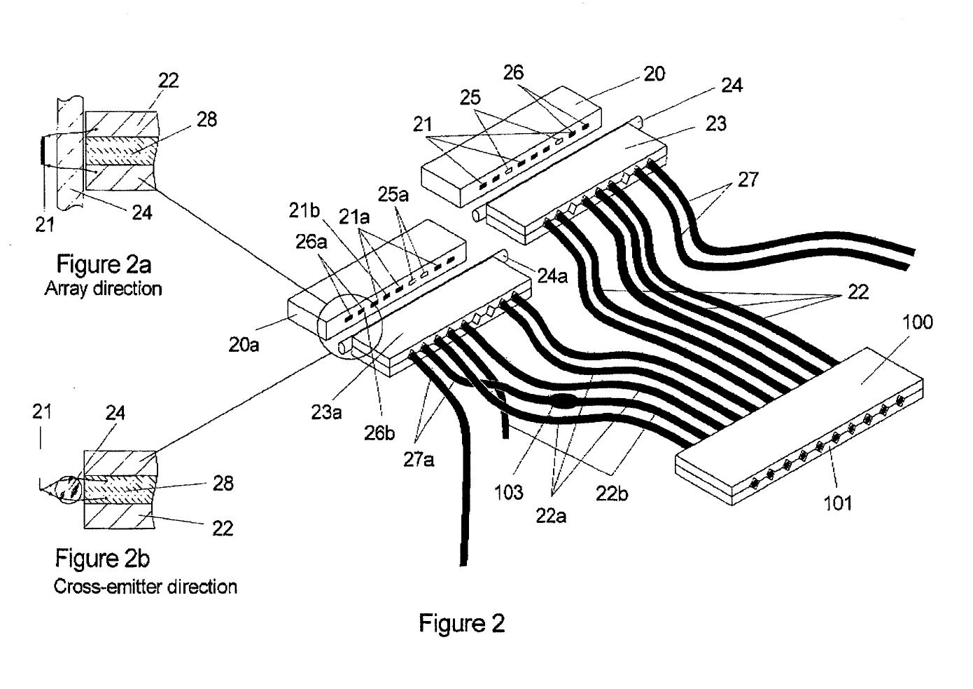

The way the present invention treats the issue of using IALDA devices with initially (from production) non-functioning emitters is to couple the IALDA device to an arranged bundle of optical fibers, as illustrated in FIG. 2. FIG. 2 schematically presents an IALDA device 20 with a plurality of emitters 21. Some of the emitters (25) are initially (from the manufacturing process) not functioning. The emitters 21 are coupled to an array of optical fibers 22, arranged in a V-groove or similar assembly 23 (for simplicity this type of assembly will be referred to only as a V-groove hereinbelow, keeping in mind that other types of planar fiber arrangements are also possible). The number of V-grooves in the assembly 23 and their pitch equals the total (functioning and non-functioning) number of emitters in the IALDA device 20 and the emitters' pitch, respectively. The coupling is made with a single anamorphic lens 24, common to all emitters 21. The lens 24 alters the beam numerical aperture only in the cross emitter direction, without changing the numerical aperture in the array direction (FIGS. 2a and 2b).

It can be seen from FIGS. 2a and 2b, that part of the energy emitted may be lost, not reaching the fiber's core 28, because the width of the beam in the emitter length direction may be bigger than the core. The amount of energy lost depends on the dimensions of the emitter 21, the fiber's core diameter and the focal length of the lens 24. Calculations and experiments show, for example, that for a 60 μm emitter and 60 μm fiber core diameter, if a short-focal-length lens 24 is used (several tens of microns), the coupling efficiency can be as good as 85%. It is important to emphasize that due to the fact that the lens 24 is positioned close to the fiber' entrance, the coupling efficiency is almost unaffected by the emitter array's non-linearity in the cross-emitter direction. This makes the demands on the IALDA production weaker and further decreases the cost of the device.

In FIG. 2, lens 24 is illustrated as cylindrical. It will, however, be appreciated by any person skilled in the art that other anamorphic lens types, including aspherical, can be used.

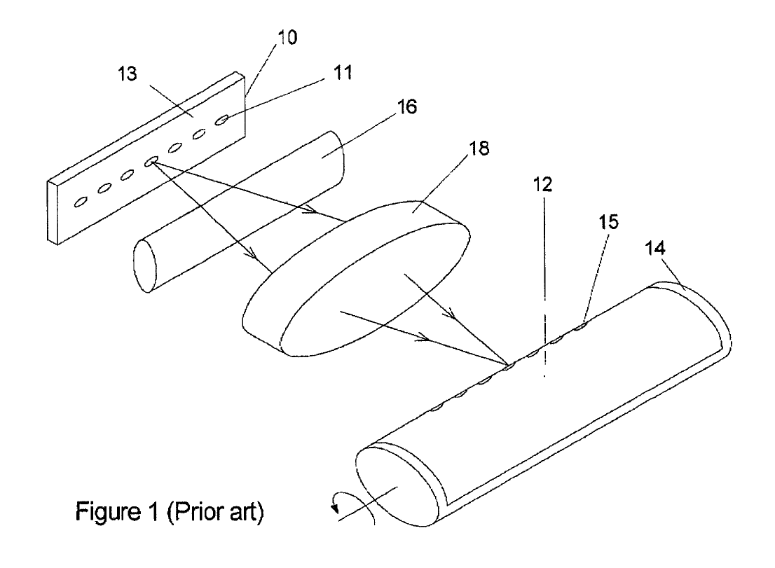

In FIG. 2 the initially non-functioning emitters are designated by numeral 25. In a classical IALDA-based imaging system, such as illustrated in FIG. 1, a laser array with non-functioning emitters cannot be used, because the light sources in the array would not be equidistant. Coupling to a fiber array, however, allows for arranging the second end of the fibers in a consecutive array of equidistant sources, by using a second V-groove assembly 100. The V-grooves pitch in die assembly 100 can be made different from the pitch of the emitters 21 (and the V-grooves in 23). The output of assembly 100 is an array of equidistant light sources 101, then imaged on the medium using techniques well known in the art.

Coupling an IALDA to an array of fibers also allows for relatively easy increase in the number of channels in the imaging device. For example, FIG. 2 illustrates a second IALDA device 20a, coupled to a second array of fibers 22a, arranged in a second V-grove assembly 23a. The fibers 22a are also arranged so that no fibers are assigned to initially non-functioning emitters 25a. Further, fibers 22a from the second assembly 23a are arranged together with the fibers 22 from the first fiber assembly 23 in a V-groove assembly 100, to form a sequence of equidistant light sources 101. These sources are then imaged on the medium using techniques well known in the art (lens 18, FIG. 1).

FIG. 2 also illustrates the increased redundancy of emitters in the proposed embodiment. In each IALDA device a number of emitters are left for spare and do not take part in the imaging process. As an example, two emitters 26 of IALDA 20 and 26a of IALDA 20a are left as spare. Their corresponding fibers 27 and 27a arc initially left free and are not arranged in the corresponding assemblies 23 and 23a. If, at some later stage of the imaging system operation, say emitter 21b of IALDA 20a fails, instead of replacing the entire device 20a or the entire optical head, there is now a possibility to engage one of the spare emitters 26a in place of the failed emitter. (In FIG. 2 this specific emitter is designated by 26b.) This operation involves cutting off the fiber 22b associated with the failed emitter 21b and connecting it to the fiber of the spare emitter 26b by using well known in the art fiber fusion 103. A service engineer usually performs this half-hour operation.

The embodiment of FIG. 2 additionally offers the advantage of replacement of any IALDA device, consisting the steps of:

1) Cutting off the corresponding fibers (for example all fibers 22)

2) Dismounting the failed IALDA device;

3) Mounting the replacing IALDA device; and

4) Optically connecting the newly mounted IALDA device by performing fiber fusion for each working channel.

In this replacement operation the position of imaged assembly 100 is not affected and therefore no additional optical adjustments are required. A service engineer, however, should perform the replacement, as it requires specialized equipment and highly skilled operations of optical fiber fusion.

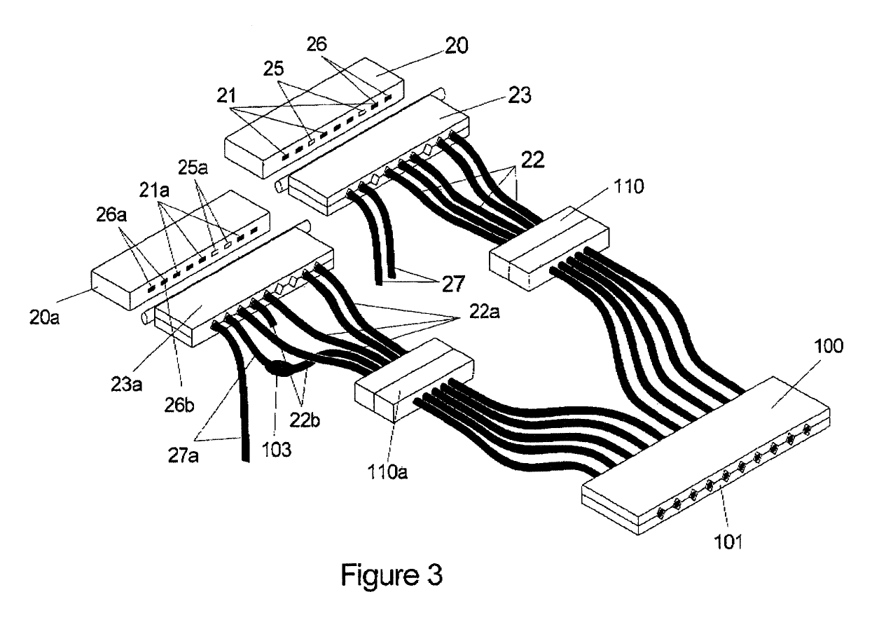

An even easier method of IALDA replacement is disclosed in another preferred embodiment of the present invention, schematically illustrated in FIG. 3. This embodiment generally has the same features, same capabilities and same performance as the embodiment of FIG. 2 and therefore all identical elements are designated with same numerals. In addition to these features, however, there are multi-fiber connectors 110 and 110a added to the design, allowing for easy and fast IALDA replacement. Multi-fiber connectors are widely used in communication technologies and are offered by many companies active in the field, such as Schott from Germany. Because these are usually snap-on, self-aligning connectors with very low insertion losses (typically 0.3 dB) with fibers arranged in arrays, the process of replacement of a failed IALDA device is simple and easy:

1) The failed IALDA device's fibers are disengaged by opening the connector (110 or 110a);

2) The failed IALDA device is dismounted;

3) The replacing IALDA device with same fiber arrangement and same connector is mounted;

4) The newly mounted device's fibers are engaged by closing the connector (110 or 110a).

The process described above does not require sophisticated optical adjustment, because the mechanical position of the assembly 100 is not affected by the replacement. It also does not require a highly qualified service engineer's involvement and therefore can be done even by the system operator, without transporting the system (or the optical head) to a specialized repair center.

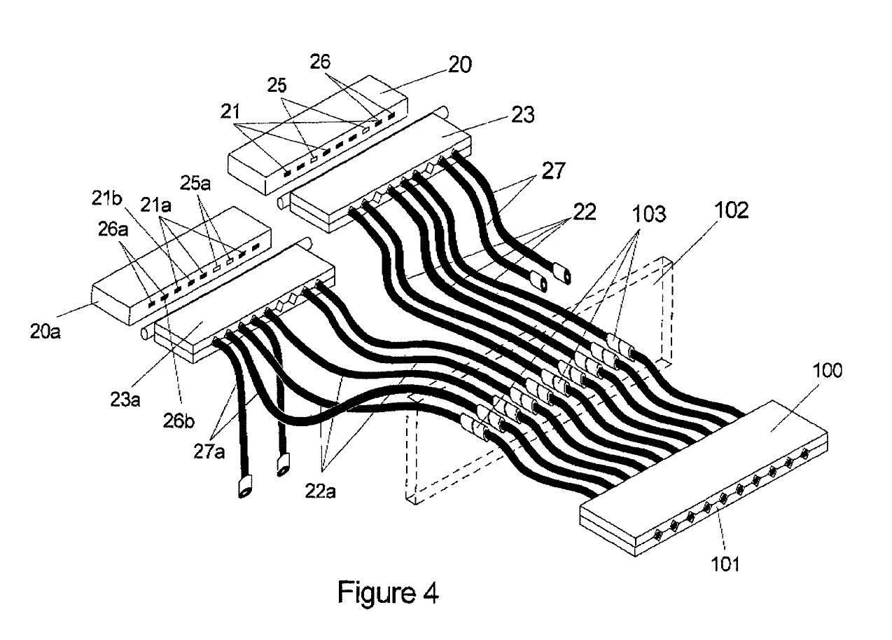

FIG. 4 presents yet another preferred embodiment of the present invention. In this embodiment the IALDA devices 20 and 20a are coupled to optical fibers in the same manner as in the embodiment from FIG. 2. Same featuring elements are designated by same numerals in both figures. The difference in die embodiment of FIG. 4 is that the connection between the V-groove assemblies 23 and 23a, and the V-groove assembly 100 is done through optical switchboard 102, consisting of single-fiber optical connectors 103. The number of optical connectors 103 at least equals the number of the initially functioning emitters (21 and 21a) in all the participating IALDA devices, minus the total number of emitters left for spare (26 and 26a). In the example of FIG. 4 each IALDA has 7 initially functioning emitters (totally 14), out of which 2 are left spare (totally 4). Therefore, the assembly 100 has a total of 10 V-grooves. Such an arrangement provides the system operator with the ability to switch between failed emitter 21b and spare emitter 26b by simply disconnecting the first one from the switchboard and connecting the second one, as illustrated.

The embodiment of FIG. 4 also offers the advantage of replacement of any IALDA device, consisting the steps of:

1. Disconnecting corresponding fibers from the switchboard 102;

2. Dismounting the failed IALDA device;

3. Mounting the replacing IALDA device; and

4. Connecting the corresponding fibers to the switchboard 102. In this replacement operation the position of imaged assembly 100 is not affected and therefore no additional optical adjustments are required. The replacement does not include highly skilled operations and can be performed by the system operator.

The system of FIG. 4 can also be equipped with a signalization sub-system (not illustrated), showing the status of every working emitter and providing the system operator with the necessary information for switching between failed and spare emitters.

In any other aspect the functionality of the embodiment of FIG. 4 is the same as the one of FIG. 2.

It will be appreciated by any person skilled in the art that different combinations between the embodiments disclosed in FIGS. 2, 3 and 4 can be made.

It will also be appreciated by any person skilled in the art that no limitation is to be construed out of the examples using two IALDA devices. Rather, any number of IALDA devices may be used in implementing the apparatus and method of the present invention.

1. Optical imaging system comprising;
at least one Individually Addressable Laser Diode Array (IALDA) comprising a plurality of emitters, and
a plurality of optical fibers coupled in one end thereof with said emitters,
wherein second ends of at least part of said optical fibers coupled with functioning emitters are arranged in a consecutive array of equidistant sources; and
wherein one or more of said optical fibers coupled with functioning emitters are left as spare for increased redundancy.

2. The optical imaging system of claim 1, wherein said coupling of said emitters of each of said at least one IALDA with said optical fibers is made with a single anamorphic lens, common to all said emitters.

3. The optical imaging system of claim 1, wherein said consecutive array of equidistant sources comprises a V-grove assembly.

4. The optical imaging system of claim 1, additionally comprising at least one multi-fiber connector for each of said at least one IALDA, each of said at least one multi-fiber connectors comprising two detachable parts, wherein said optical fibers coupled to functioning emitters are routed through said two parts of said multi-fiber connectors.

5. The optical imaging system of claim 4, wherein said consecutive array of equidistant sources comprises a V-groove assembly.

6. Optical imaging system comprising:
at least one Individually Addressable Laser Diode Array (IALDA) comprising a plurality of emitters; and
a plurality of optical fibers coupled in one end thereof with said emitters,
wherein second ends of at least part of said optical fibers coupled with functioning emitters are connected with an optical switchboard.

7. The optical imaging system of claim 6, wherein optical fibers emerging from said optical switchboard are arranged in a consecutive array of equidistant sources.

8. The optical imaging system of claim 7, wherein said consecutive array of equidistant sources comprises a V-groove assembly.

9. Optical imaging system comprising:
at least one Individually Addressable Laser Diode Array (IALDA) comprising a plurality of emitters;
a plurality of optical fibers coupled in one end thereof with said emitters; and
a V-groove assembly for arranging second ends of at least part of said optical fibers connected to functioning emitters in a consecutive array of equidistant sources.

10. Optical imaging system comprising:
at least one Individually Addressable Laser Diode Array (IALDA) comprising a plurality of emitters;
a plurality of optical fibers coupled in one end thereof with said emitters,
one or more multi-fiber connectors, each of said multi-fiber connectors comprising two detachable parts, wherein at least part of said optical fibers coupled to functioning emitters are routed through said two parts of said multi-fiber connectors; and
a V-groove assembly for arranging second ends of said optical fibers emerging from said one or more multi-fiber connectors in a consecutive array of equidistant sources.

11. Optical imaging system comprising:
at least one Individually Addressable Laser Diode Array (IALDA) comprising a plurality of emitters;
a plurality of optical fibers coupled in one end thereof with said emitters;
an optical switchboard for receiving a second end of at least part of said optical fibers coupled with functioning emitters; and
a V-groove assembly for arranging optical fibers emerging from said optical switchboard in a consecutive array of equidistant sources.

12. A method of increasing the redundancy of an IALDA-based imaging device, comprising the steps of:
providing at least one Individually Addressable Laser Diode Array (IALDA) comprising a plurality of emitters, and
coupling a plurality of optical fibers in one end thereof with said emitters,
wherein second ends of at least part of said optical fibers coupled with functioning emitters are arranged in an array, and
wherein one or more of said optical fibers coupled with functioning emitters are left as spare for increased redundancy.

13. The method of claim 12, additionally comprising the steps of;
cutting off said one end of an optical fiber associated with a failed emitter; and
connecting said cut-off end to one of said spare emitters.

14. A method of replacing an IALDA device having a plurality of emitters and optical fibers coupled in one end thereof with said emitters, wherein second ends of at least pan of said optical fibers coupled with functioning emitters are arranged in an array, comprising the steps of:
cutting off said fibers at said second ends thereof;
replacing said IALDA device; and
optically connecting said replaced IALDA device by fusing the second ends of at least part of said optical fibers connected with functioning emitters.

15. A method of replacing an IALDA device having a plurality of emitters and optical fibers coupled in one end thereof with said emitters, wherein second ends of at least part of said optical fibers coupled with functioning emitters are connected to a multi-fiber connector, comprising the steps of:
disengaging said fibers at said second ends thereof by opening said connector;
replacing said IALDA device;
optically connecting said replaced IALDA device by engaging the second ends of at least part of said optical fibers connected with functioning emitters with said connector, and
closing said connector.

16. A method of replacing an IALDA device laving a plurality of emitters and optical fibers coupled in one end thereof with said emitters, wherein second ends of at least part of said optical fibers coupled with functioning emitters are connected to an optical switchboard, comprising the steps of:
disconnecting said fibers at said second ends thereof from said switchboard;
replacing said IALDA device; and
optically connecting said replaced IALDA device by connecting the second ends of at least part of said optical fibers connected with functioning emitters with said optical switchboard.
